(19) United States
(12) Patent Application Publication
(10) Pub. No.: US 2012/0125001 A1
(43) Pub. Date: May 24, 2012

(54) Modular Thermoelectric Converter

(76) Inventor: Thilo Ittner, Ravensburg (DE)

(21) Appl. No.: 13/376,065

(22) PCT Filed: May 31, 2010
(86) PCT No.: PCT/EP10/03300

§ 371 Date: Feb. 9, 2012

(30) Foreign Application Priority Data
Jun. 3, 2009 (EP) 09007361.0
May 26, 2010 (EP) 10163871.6

(51) Int. Cl. F03G 6/06; F02G 1/043; F03G 6/00

(52) U.S. Cl. 60/641.15; 60/641.8; 60/518

(57) ABSTRACT

A thermoelectric converter includes one or more thermoelectric converter modules. A thermoelectric converter module includes spatially delimited gas volumes interconnected by a regenerator in a gas-permeable manner. During operation of the thermoelectric converter, a first gas volume warmer than the ambient temperature or a fluid flow is heated, and a second gas volume is cooler than the first gas volume. A fluid flow is thermally coupled with the second gas volume to dissipate heat. A volume change element suited to change the size of one or more of the gas volumes can be moved or deformed by an electromagnetic component by creating a magnetic field such that the size of at least one of the gas volumes is changed.

### CROSS-REFERENCE TO RELATED APPLICATION

The present application is the entry into the national phase and claims the benefit of priority of International Patent Application No. PCT/EP2010/003300, filed May 31, 2010, which application claims priority of European Application No. 09007361.0, filed Jun. 3, 2009 and of European Application No. 10163871.6, filed May 26, 2010. The entire text of the priority applications are incorporated herein by reference in the entirety.

### FIELD OF THE INVENTION

The invention relates to a thermoelectric converter for converting heat or cold or sunlight into electric energy, or for generating heat and cold, and to a method of using the thermoelectric converter.

There are many possibilities of generating electric energy or heat and cold from sunlight. It is, for example, possible to generate electric energy with the aid of a solar-powered thermal engine and a dynamo or a generator. Then, the use of a heat pump permits the generation of heat and cold. It is further possible to directly generate cold and heat with the aid of a Vuilleumier cycle machine and solar energy.

Various approaches attempt to improve the generation of electric energy or heat and cold with the aid of sunlight with respect to a preferably high efficiency and a preferably high flexibility (e.g., with respect to different fields of application).

Thermoelectric converters are thermal engines or heat pumps, respectively, where heat or cold (e.g., generated with the aid of sunlight) is converted into electric energy, or where electric energy is used to generate heat and cold. A thermoelectric converter can furthermore be a device which converts heat and/or cold into heat and cold of optionally other temperature levels using electromagnetic components.

Depending on the field of application, thermoelectric converters can also have a modular design. A modular thermoelectric converter consists of a plurality of thermoelectric converter modules which are coupled to each other. An analogous example of this is, e.g., a multicylinder combustion engine where each piston of a cylinder is coupled to the other pistons by means of a crankshaft.

The object underlying the disclosure described below is to increase the efficiency of a thermoelectric converter module and/or to couple a plurality of thermoelectric converter modules as effectively as possible with respect to the efficiency, and to a flexible field of employment. By this, incident solar radiation can be particularly effectively and flexibly utilized, for example in an application as a flat-plate collector on building roofs.

### SUMMARY

This object is achieved with a thermoelectric converter according to claim 1 and with a method according to claim 14. Further embodiments of the disclosure are disclosed in the depending claims.

Further aspects of preferred and possible embodiments of the disclosure will become clear with reference to FIGS. 1 to 20. In the figures:

### BRIEF DESCRIPTION OF THE DRAWINGS

FIG. 1 shows a flat-plate collector with Vuilleumier cycle modules;

FIG. 2 shows stirling modules which can be employed instead of the Vuilleumier cycle modules in FIG. 1;

FIG. 3 shows duplex stirling modules which can be employed instead of the Vuilleumier cycle modules in FIG. 1;

FIG. 4 shows a thermoelectric converter for the application as a solar system;

FIG. 5 shows constructive details for absorbers and movement limiting elements;

FIG. 6 shows the effect of a movement limiting element by chronological sequences of

a) current or force,

b) force and

c) current;

FIG. 7 shows a flexibly designed heat pump or thermal engine, respectively;

FIG. 8 shows tracking devices for sunlight for
a) hollow mirrors and
B) lenses;

FIG. 9 shows double- or multiple-acting Vuilleumier cycle machines, namely

a) a coupled Vuilleumier cycle machine, and

b) a double-acting Vuilleumier cycle machine,

c) a multiple-acting Vuilleumier cycle machine;

FIG. 10 shows a hollow or;

FIG. 11 shows a Vuilleumier cycle machine with gas springs and a hollow mirror;

FIG. 12 shows a Vuilleumier cycle machine with gas springs;

FIG. 13 shows a Vuilleumier cycle machine with gas springs;

FIG. 14 shows a thermoelectric converter with an optional cylinder;

FIG. 15 shows a double- or multiple-acting Vuilleumier cycle machine;

FIG. 16 shows a duplex stirling;

FIG. 17 shows a Vuilleumier cycle machine with membranes;

FIG. 18 shows a flat modular stirling;

FIG. 19 shows a representation of modes of piston oscillations; and

FIG. 20 shows a representation of the countercurrent principle.

### DETAILED DESCRIPTION

The thermoelectric converter serves to convert heat and/or cold or sunlight into electric energy, or to generate heat and cold, and it includes one or a plurality of thermoelectric converter modules. A thermoelectric converter module includes at least two spatially delimited gas volumes which are interconnected by an immobile or mobile regenerator in a gas-permeable manner. A first gas volume is a gas volume which is, during operation of the thermoelectric converter, warmer than the ambient temperature or warmer than a fluid flow (e.g., for cooling the second gas volume). The first gas volume is heated either with the aid of an optical element, for example a hollow mirror or a lens, or it is heated by thermal coupling to a fluid, for example a cooling liquid or a waste gas, or to a solid body, for example a metal heat conductor. A second gas volume is a gas volume which is, during operation of the thermoelectric converter, colder than the first gas volume. Furthermore, a thermoelectric converter module includes at least one volume change element which is suited to change the size of one or more of said gas volumes.

The thermoelectric converter is in some instances characterized in that a volume change element can be moved or deformed with the aid of an electromagnetic component, for example a magnet or an electrically conductive coil or one/several short-circuited electric conductors by creating a magnetic field, such that the size of at least one gas volume is changed. Typically, by means of a volume change element, two gas volumes are simultaneously changed. In the process, one gas volume is normally increased while a further gas volume is simultaneously reduced in size. The electromagnetic component can be an electrically conductive coil into which a voltage is induced by a movement relative to a magnetic field or by the change of a magnetic field in the region of the coil (electromagnetic induction), or which can be moved by applying an electric voltage to the coil relative to the magnetic field. A preferred embodiment is a plunger coil. The electromagnetic component can be furthermore designed in the form of a multi-solenoid drive where a locally varying magnetic field created by a permanent magnet can be accelerated or decelerated by several periodically arranged coils. Furthermore, the electromagnetic component can be designed in the form of a linear asynchronous drive where short-circuited electric conductors can be accelerated or decelerated by means of periodically arranged coils. For this, both in the multi-solenoid drive and in the linear asynchronous drive, the coils create a migrating magnetic alternating field with a defined frequency and velocity of migration.

The thermoelectric converter is in additional instances furthermore characterized by a first fluid flow region for a first fluid flow for dissipating heat, where the above-mentioned second gas volume of the thermoelectric converter module or the above mentioned second gas volumes of the respective thermoelectric converter modules are thermally coupled to this first fluid flow. The temperature of the fluid flow can be controlled by varying the flow rate. As an alternative, a thermoelectric converter is also possible in which the thermoelectric converter modules are at least partially not thermally coupled via a fluid flow, or in which groups (e.g., rows) of thermoelectric converter modules are each coupled to a separate fluid flow.

As a volume change element, a movable piston, a rotary piston, a rotating piston, a gas spring, a movable or deformable membrane or a movable regenerator is possible. In case a thermoelectric converter module includes more than one volume change element, combinations of the above mentioned possibilities can also be employed.

The thermoelectric converter can include at least three times three, or four times four, or at least five times five thermoelectric converter modules. As an alternative, a thermoelectric converter can include x times y thermoelectric converter modules, where 1≦x≦3, 8, 16 or 100, and 1≦y≦3, 8, 16 or 100. The thermoelectric converter modules are typically arranged in a plane. However, it is also possible to arrange thermoelectric converter modules in layers one upon the other or in a row. Furthermore, the thermoelectric converter in some instances can be characterized in that the majority of the thermoelectric converter modules is designed to be adaptable to a surface, or the thermoelectric converter modules are movable relative to each other. By this, the thermoelectric converter can be used, for example, as a chilled ceiling.

Furthermore, the thermoelectric converter can include a second fluid flow region for a second fluid flow for dissipating cold. The respective third gas volumes of the corresponding thermoelectric converter modules are thermally coupled to the second fluid flow. A third gas volume of a thermoelectric converter module is defined in that during operation of the thermoelectric converter, this third gas volume is colder or warmer than the corresponding second gas volume of a thermoelectric converter module, and preferably also colder or warmer than the ambient temperature. In a preferred embodiment, the first fluid flow and the second fluid flow flow in opposite directions, so that in a first thermoelectric converter module, both fluid flows have maximum temperatures, and in a last thermoelectric converter module, both fluid flows have minimum temperatures. It is achieved by the countercurrent principle that the temperature difference between warm and cold is preferably small in each thermoelectric converter module to be able to ensure high efficiency and thus an effective working manner of each thermoelectric converter module when used as a heat pump.

Furthermore, a thermoelectric converter module can include a movement limiting element to limit the movement of the respective volume change element. A movement limiting element can be, for example, a spring, a gas spring, a stop, a magnetic element or an electronic element for controlling the electromagnetic component. As an alternative, the volume limiting elements can also mutually function as movement limiting elements, for example by magnetic repulsion. A movement limiting element can limit the movement of the respective volume change element, such that the volume change element can perform an oscillation deviating from a sine shape. To optimize the efficiency of a thermoelectric converter module, an oscillation is preferred which has an approximately rectangular shape. So, the movement limiting element can contribute to the mode of oscillation being (approximately) flat in the maximum or minimum excursion range.

A thermoelectric converter module can be a stirling module, a duplex stirling module, a double- or multiple-acting stirling module, a Vuilleumier cycle module, or a single-, double- or multiple-acting Vuilleumier cycle module. A thermoelectric converter can either include only one type of converter modules, or it can include any arbitrary combination of different converter modules. With the aid of a thermoelectric converter, electric current, mechanical work, heat, cold or any arbitrary combination of the above-mentioned possibilities can be generated.

In a double-acting thermoelectric converter, at least one volume change element or gas volume is provided such that it cooperates in two (otherwise independent) processes, e.g., in a stirling process or a Vuilleumier cycle process. A volume change element of a thermoelectric converter module here simultaneously forms a volume change element of a further thermoelectric converter module, or a gas volume is simultaneously a component of two thermoelectric converter modules. In a multiple-acting converter, at least one thermoelectric converter module has a first common volume change element with a first further thermoelectric converter module, and a second common volume change element with a second further thermoelectric converter module, or a first gas volume is used by a first and a second thermoelectric converter module, and a second gas volume is used by the first and a third thermoelectric converter module.

In a preferred embodiment, in case the thermoelectric converter includes a plurality of thermoelectric converter modules, the thermoelectric converter modules are coupled by means of electromagnetic components via polyphase current. The phase differences between two adjacent thermoelectric converter modules can be, for example, 90°, 120° or 180°. However, it is also possible that the phase difference between two adjacent thermoelectric converter modules is less than 90°. With a high number of thermoelectric converter modules, the phase difference between two adjacent thermoelectric converter modules can also be selected to be inversely proportional to the number of thermoelectric converter modules. It is furthermore possible to operate a selection (i.e. not all) of the thermoelectric converter modules, or to operate all of them synchronously (that means without phase difference).

In another preferred embodiment, the electric energy which is formed in the deceleration of a volume change element by induction is used to accelerate another volume change element. Furthermore, this electric energy can be completely or partially intermediately stored in a capacitor or an accumulator before it is used again for the acceleration of another or the same volume change element.

In another preferred embodiment, the thermoelectric converter includes a control system for controlling the oscillation frequency, amplitude and mode of oscillation of each volume change element of the thermoelectric converter modules, and for controlling the phase shift between the volume change elements of a thermoelectric converter module and between the different thermoelectric converter modules. The oscillation frequency, amplitude, mode of oscillation and phase shift of each volume change element are controlled with the aid of the respective electromagnetic component of the thermoelectric converter modules. For this, a control apparatus controls the flows in the electromagnetic components by open-loop or closed-loop control such that the volume change elements are each decelerated or accelerated such that they perform the desired mode of oscillation. During deceleration, they release energy to the electromagnetic components, during acceleration, the electromagnetic components supply energy to them. In addition or as an alternative, the thermoelectric converter can include a device for converting the energy supplied or released by the thermoelectric converter modules to another form of electric energy, for example alternating current with a predefined frequency. It is further possible to determine, with the aid of a control system, whether the thermoelectric converter is to preferably generate electric energy or preferably generate heat and/or cold. By means of the control system, the proportion of electric energy generation or the proportion of heat and/or cold generation can then be determined.

In another embodiment, light emerging from one or several optical element(s) is forwarded by means of light conductors, such as a glass fiber, to one of the first gas volumes. Light shining into a first gas volume is converted into heat by means of a light absorber. Preferably, the light absorber is located in the focus of the incident light. Preferably, a first gas volume is at least partially surrounded by a heat-insulating layer, so that this gas volume can be easily heated with the aid of the incident light and the absorber. In the region where light enters the gas volume, the layer is preferably transparent to light and simultaneously heat-insulating. This can be achieved, for example, by a double-walled glass envelope which is evacuated.

Volume change elements of the thermoelectric converter can also be loose pistons which are only moved with the aid of pressure differences in the corresponding gas volumes and/or gas springs, or with the aid of electromagnetic fields. Loose pistons are not moved or held in position by means of a mechanical rod assembly, so that in case of loose pistons, construction is less complex than in case of mechanically moved pistons. Loose pistons are moved within a cylinder with a circular or any other base and guided by the cylinder wall. However, loose pistons can also have areas of different diameters/different bases and be correspondingly moved in cylinders with areas of different bases. They can moreover contain areas which only serve to guide the piston, or areas which serve to form a gas spring. Loose pistons can possess a connection to the cylinder which is adapted to transmit electric current, for example a multiwire electric conductor. However, loose pistons are not connected to the cylinder by means of a mechanical spring such that the spring exerts a force on the loose piston or that the repulsive force of the mechanical spring towards the center of the oscillation movement is higher than the repulsive force by compressed or expanded gas volumes within the cylinder (the mean being taken across the complete path of the piston). It is furthermore possible that the electromagnetic component (e.g., coil) for moving a volume change element simultaneously functions as a regenerator which also represents a constructive simplification.

Furthermore, the thermoelectric converter in some instances can be characterized in that the volume change element can perform an oscillation whose oscillation frequency differs from the resonant frequency of a corresponding volume change element not coupled by an electromagnetic component by at least 10%, 25%, 50% or 75%. Furthermore, the waveform of such oscillation can also differ from an uncoupled oscillation. Therefore, a thermoelectric converter is possible in which the volume change element can perform an oscillation which is approximately rectangular and/or trapezoidal. Such oscillation can also be defined in that the volume change element can perform oscillations whose waveform include a gradient in the turning points which differs from the gradient in the turning points of a corresponding sine waveform having the same wavelength and amplitude by at least 10%, 20%, 30% or 50%. The turning point is the point in time at which the deflection (mathematically the second derivative) of the function excursion over time changes its mathematical sign. Preferably, the latter difference is such that the absolute value of said gradient is preferably higher than the corresponding absolute value of a gradient of a sine waveform of the same wavelength and amplitude. Such deviation of the oscillation waveform of the volume change element according to this disclosure leads to an improved efficiency compared to thermoelectric converters which typically perform sine waves.

For the volume change elements to be able to perform an approximately rectangular or trapezoidal mode of oscillation, the electromagnetic components, the movement limiting elements, the gas pressure, springs, weight and/or gas springs are dimensioned or controlled by open-loop or closed-loop control such that at least two local acceleration maximums (related to the function acceleration over time) act on the volume change elements during a half-wave (or between two passages through the center of movement). These acceleration maximums on the one hand serve to decelerate, and on the other hand to increase the speed of the volume change element.

In another preferred embodiment, the thermoelectric converter has Vuilleumier cycle modules which have a displacing piston with an immobile regenerator and a mobile regenerator. As an alternative, a Vuilleumier cycle module can also has two mobile regenerators or two displacing pistons with two immobile regenerators. Furthermore, the thermoelectric converter modules of the thermoelectric converter can also be double- or multiple-acting Vuilleumier cycle modules, three gas volumes with different temperature ranges each being allocated to each Vuilleumier cycle module. In a preferred embodiment, two, four or more than four Vuilleumier cycle modules are each arranged such that a volume change element of a first Vuilleumier cycle module that can change its first and second gas volumes is mechanically coupled to a further volume change element of a second Vuilleumier cycle module such that both volume change elements can be accelerated and decelerated by means of the same electromagnetic component. The same applies to each further Vuilleumier cycle module and the respective following Vuilleumier cycle module, the volume change element between the first and the second gas volumes of the last Vuilleumier cycle module being in turn mechanically coupled to a volume change element of the first Vuilleumier cycle module.

In an exemplary embodiment, the Vuilleumier cycle modules are coupled to each other such that there are gas volumes with the warmest and the coldest temperature ranges which are each allocated to two adjacent Vuilleumier cycle modules, one mobile regenerator each being located between two adjacent gas volumes, and the mobile regenerators being coupled to each other by means of electromagnetic components. In a further exemplary embodiment, three gas volumes each are coupled via regenerators, each of said three gas volumes being divided into two regions by one displacing piston each, and said three displacing pistons being coupled to each other by means of electromagnetic components. In a further exemplary embodiment, three gas volumes each are coupled via regenerators, each of said three gas volumes being divided into more than two regions by several displacing pistons, and said displacing pistons being coupled to each other by means of electromagnetic components. In all three cases, coupling by electromagnetic components permits the volume change elements (mobile regenerators or displacing pistons) to move relative to each other with fixed phase shifts. In all three cases, the phase shifts can be selected such that the efficiency of the corresponding thermoelectric converter is maximized, or that, apart from heat and cold, even electric energy is generated. It is furthermore possible to select the phase shifts of the mobile regenerators or displacing pistons of the different gas volumes such that, apart from heat and/or cold, electric energy is also generated.

It is furthermore possible to use a thermoelectric converter as a heat pump (for generating heat and/or cold) supplying electric (or mechanical) energy. In operation as a heat pump, the volume change elements are moved, for example, by electric energy supplied to the thermoelectric converter from outside (by generating magnetic fields changing over time).

According to a method of using the thermoelectric converter, first, the thermoelectric converter is arranged such that it is exposed to light (typically sunlight) and/or heat and/or cold. By means of light or heat, the respective first gas volumes of the thermoelectric converter modules are heated. Then, the thermoelectric converter generates electric current and/or mechanical work and/or heat and/or cold. By means of suited control means (e.g., by changing the phase shift of the volume change elements within the thermoelectric converter modules), it is possible to determine the proportions of electric current, mechanical work and heat and cold. It is, for example, possible to operate the thermoelectric converter such that it exclusively generates electric current and waste heat, or that it exclusively generates heat and cold. As an alternative or in addition to the generation of electric current, mechanical work can also be generated. If the thermoelectric converter is operated with cold, it is coupled to the respective third gas volumes, so that thermal energy is pumped from the fluids coupled to the respective second gas volumes to the fluids coupled to the respective first gas volumes.

The method furthermore relates to the control of the temperature of the fluid flow by means of the flow rate of the fluid flow. This means, the slower a fluid flows past the corresponding gas volumes, the more the fluid flow adopts the temperature of the gas volumes, and the faster a fluid flows past the corresponding gas volumes, the more the fluid flow maintains its temperature. A slow flow rate makes sense, for example, if the fluid should preferably adopt the temperature of the corresponding gas volumes, as is the case when utilizing the generated heat or cold, respectively. If the fluid flow only serves to cool the corresponding gas volumes, a high flow rate is advantageous as in this case, the cooling effect of the fluid is higher than with a slowly flowing fluid.

Another aspect of the disclosure relates to a method in which the thermoelectric converter is exposed to the temperature difference between the ambient temperature on the one hand and a heat accumulator, a cold accumulator, a fluid thermally coupled to the ground, a fluid or heat conductor (e.g., of metal) heated by light, or a generator of waste heat on the other hand, to thus heat or cool a building, a motor vehicle, a heat accumulator or a cold accumulator. Equally, the thermoelectric converter can be used to supply heat to the heat accumulator and/or cold to the cold accumulator. Here, the ambient temperature can be warmer or colder than the other heat source/sink used to operate the thermoelectric converter. A heat accumulator can be, for example, a latent heat accumulator device or a warm water tank, a cold accumulator can be, for example, a tank with liquid nitrogen.

A displacing piston and an adjacent gas volume, and/or a spring, and/or a gas spring can be understood as a mechanical oscillator which has a resonant frequency which are defined on the one hand by the compressibility of the gas in the gas volume and the sum of the other forces acting on the piston, and the mass of the displacing piston or a mass coupled to it. The thermoelectric converter, however, is operated such that it preferably oscillates outside the range of the resonant frequency. This is achieved, e.g., by electromagnetically coupling the different components, such as a displacing piston and/or regenerator which defines an oscillation frequency of a displacing piston and/or a regenerator. The resonant frequency of a piston or mobile regenerator, respectively, defined by the mass of a mobile piston or regenerator and by mechanical restoring forces, such as spring force, pressure force by a compressed gas and mechanical damping, and its working frequency changed by electromagnetic coupling or its actual working frequency, can significantly vary (e.g., more than 10%, more than 50%, more than 100%, more than tenfold, or more than hundredfold). Operation outside the mechanically defined resonant frequency permits very small masses, e.g., of a displacing piston as the latter does not have to intermediately store energy in the form of kinetic energy (though it can do it). Energy storage can rather (additionally) be accomplished by electric energy or by coupling to other pistons. Furthermore, operation at different frequencies is possible in the present disclosure, meaning a wide applicability with respect to amounts of energy to be converted without clearly deteriorating efficiency in the process. By this, the present converter differs from conventional free-piston stirling or Vuilleumier cycle machines which intermediately store the energy between expansion and compression or between enlargement and reduction of the working spaces largely in the form of the kinetic energy of the piston movements and are thus fixed to the operation at a certain resonant frequency.

When removing or dissipating heat through a fluid flow, the fluid adopts an elevated temperature via the heat exchanger by contact with a thermoelectric converter module, i.e., the fluid flow receives thermal energy from the module. This corresponds to the generation of heat as the heated fluid flow can be utilized as a source of heat (e.g., outside the thermoelectric converter).

When removing or dissipating cold through a fluid flow, the fluid adopts a lower temperature via the heat exchanger by contact with a thermoelectric converter module, i.e., the fluid flow releases thermal energy to the module. This corresponds to the generation of cold as the cooled down fluid flow can be utilized as a source of cold (e.g., outside the thermoelectric converter).

A further aspect is the use of one or several tapering coils which act on pistons as eddy current brakes or eddy current accelerators. Here, the kinetic energy of a piston is converted into electric energy. A tapering coil is defined as a coil having a variable winding density (i.e., the winding density is reduced towards the tapering end). By means of tapering coils, the speed of a piston can be better taken into consideration: a fast piston first only generates an induction voltage by interaction with the tapered end of the coil. The higher the overlap of a piston with a coil is, the higher the winding density and thus also the deceleration effect will be, i.e., the slower the piston movement will be. By the increasing winding density of a coil with a greater overlap of a piston with a coil, one can achieve that the generated induction voltage can reach a similarly high level as in a correspondingly faster piston (with less overlap) even with relatively slow piston movements (compared to non-decelerated piston movements). Moreover, the higher winding density of a coil in the region of the maximum overlap with a corresponding piston has the effect that the piston can be decelerated in said region with a maximum overlap (down to a temporary standstill of the piston).

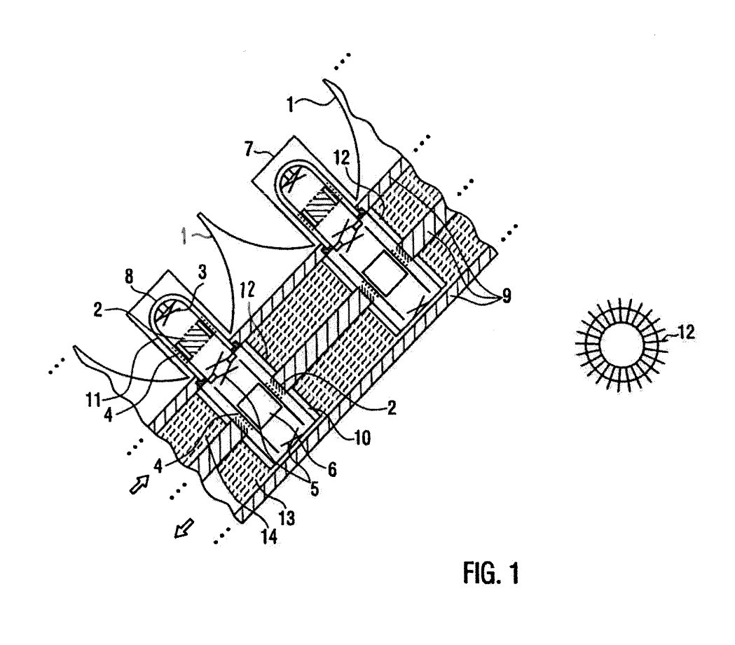

FIG. 1 shows a thermoelectric converter which is embodied as a flat-plate collector with Vuilleumier cycle modules. The upper end of each of said Vuilleumier cycle modules is heated by means of a hollow mirror 1 by focusing incident light through the hollow mirror 1 to an absorber 3 which, as a movement limiting element, can furthermore include a spring, whereby heat is formed. To better store the heat, this upper part of a Vuilleumier cycle module is surrounded by a vacuum 8. This vacuum 8 is typically located between two walls of transparent material, such as glass (such walls are advantageous because incident light can preferably impinge on the absorber 3 without obstacles). Instead of heating with light, heating by thermal contact with a fluid, such as a gas or a liquid, can be provided. Such heating facility by contact with the fluid can also be provided in addition to a light heating. The fluid for heating can, e.g., be the waste gas of an engine, or cooling water from a cooling circuit, for example from an engine of a motor vehicle. Furthermore, each Vuilleumier cycle module includes two coils 4. The latter function to move a mobile regenerator 2 or a displacing piston 6, or to convert kinetic energy into electric energy by movements of the regenerator 2 or of the displacing piston 6 by electromagnetic induction. The displacing piston 6 displaces gas from the gas volume situated above it or from the gas volume situated below it, so that gas flows from one volume to the corresponding other volume. During this process, the displaced gas flows through the stationary (not mobile) regenerator 2 which in the process takes up heat from the gas flowing through it or releases heat to the gas flowing through it. The movements of the mobile regenerator 2 and the displacing piston 6 are limited by movement limiting elements 5 (e.g., springs). In an alternative embodiment, mobile regenerators and displacing pistons could be also coupled to the movement limiting element or the absorber by means of springs, e.g., to react to gravity in a vertical construction. While the upper region 11 of a Vuilleumier cycle module has a bad thermal conductivity, the lower region 10 of a Vuilleumier cycle module has good thermal conductivity (parts of the lower region 10 can be made, for example, of aluminum). The lower part of a Vuilleumier cycle module is thermally coupled to two fluid flows 14, 13, wherein the fluid flow for heat transfer 14 and the fluid flow for cold transfer 13 flow in opposite directions (shown by arrows). Each Vuilleumier cycle module includes three volumes of different temperature ranges. Energy in the form of light is supplied to the uppermost volume with the absorber 3, so that this volume is the warmest one of said three volumes. In the central volume between the regenerator 2 and the displacing piston 6, heat is withdrawn from the Vuilleumier cycle module as heat is here dissipated to the fluid flow 14. Cold is generated in the lowermost volume (underneath the displacing piston 6), taken up by the fluid flow 13 and carried away. The various warm regions of all Vuilleumier cycle modules or fluid flows are thermally separated by insulations 9. Furthermore, each Vuilleumier cycle module can include one or two elements with heat exchanger wings 12 for more efficiently passing on heat or cold to the corresponding fluid flow. It is also possible for a hollow mirror 1 to include a recess 7, so that the hollow mirror 1 can be moved relative to the allocated Vuilleumier cycle module. It is thereby possible to move the hollow mirror 1, e.g., in order to be able to orient the hollow mirror 1 such that it can catch sunlight as efficiently as possible.

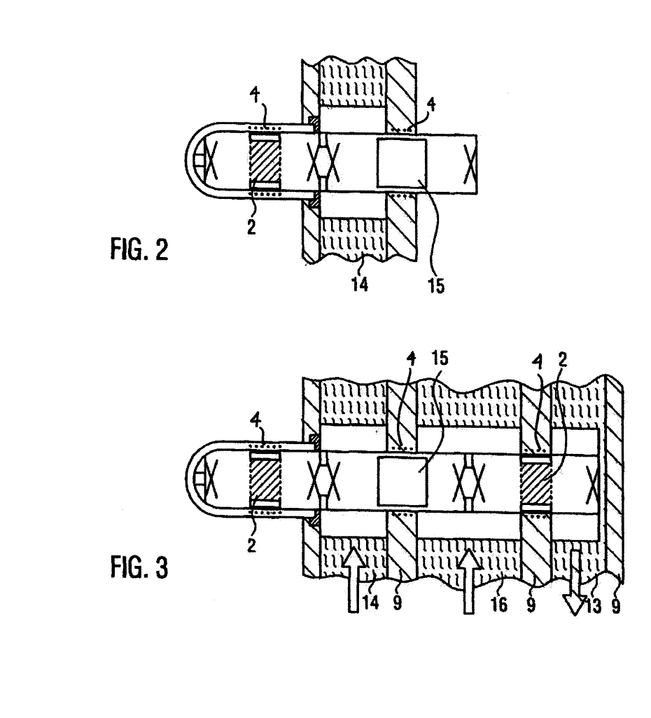

As an alternative to the Vuilleumier cycle modules, stirling modules or duplex stirling modules can also be employed in the flat-plate collector of FIG. 1, these being shown in FIGS. 2 and 3. In the stirling module of FIG. 2, two volume change elements are employed, that is a mobile regenerator 2 and a working piston 15. In case of the duplex stirling module of FIG. 3, two mobile regenerators 2 and one mobile working piston 15 are used. In this case, three fluid flows are required, namely fluid flow 13 for cold transfer, fluid flow 14 for heat transfer, and another fluid flow 16 for heat transfer. The flow directions of the fluid flows 14 and 16 flow into the same direction, whereas fluid flow 13 flows into the opposite direction with respect to fluid flows 14 and 16, respectively (the flow directions are shown by arrows). Furthermore, thermoelectric converters are possible where combinations of the different thermoelectric converter modules are employed (e.g., Vuilleumier cycle modules and stirling modules and duplex stirling modules).

The volume change elements 2, 6 and 15 are coupled to each other by means of electromagnetic components 4 (coils), so that the movements of the volume change elements 2, 6 and 15 are correlated by corresponding phase shifts. It is possible to control or determine the phase shifts between the volume change elements 2, 6 and 15 of a thermoelectric converter module or else several thermoelectric converter modules by means of a control system. By this, an oscillation frequency for the operation of the modules is also achieved which is outside a mechanically defined resonant frequency, which would be defined, among other things, also, e.g., by the mass of a displacing piston.

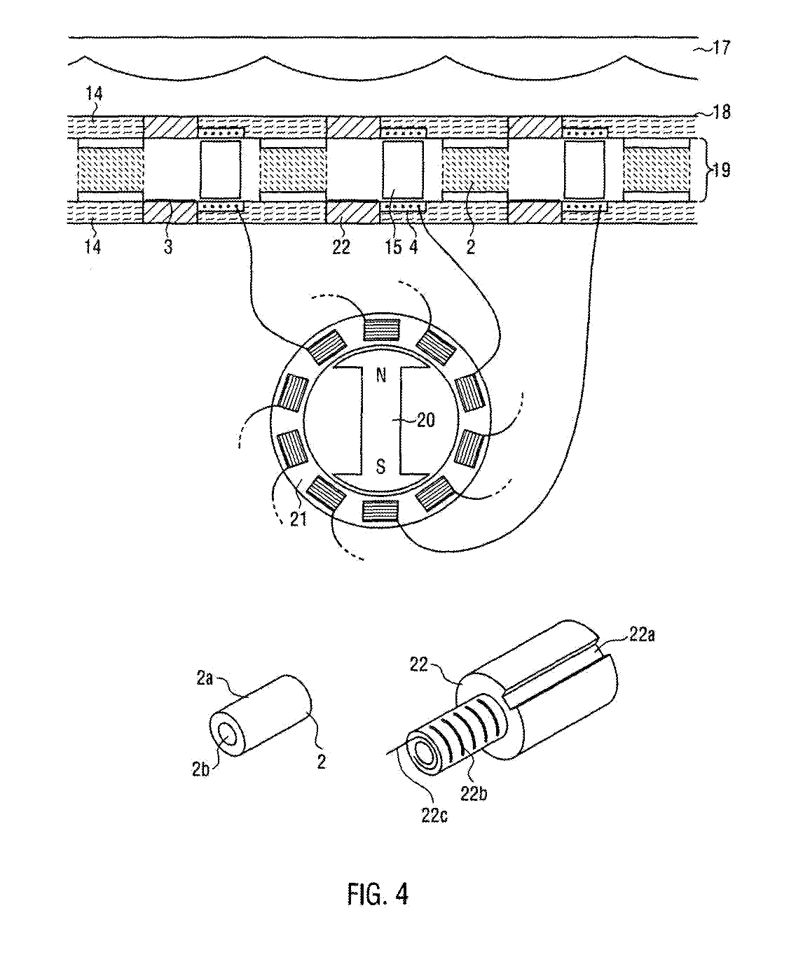

FIG. 4 shows a complete system for the application of a thermoelectric converter as a solar system. A thermoelectric converter is shown in which the different components are attached one behind the other (e.g. in a tube). In an inner tube 19, immobile regenerators 2 and mobile working pistons 15 are mounted alternatingly. The inner tube 19 is surrounded by an outer tube 18, in the space of the tubes 18 and 19, a fluid flow 14 for heat transfer being employed. Heat is generated with the aid of a lense array 17 and absorber coatings 3. Instead of the lense array, an array of hollow mirrors would also be possible. The regenerators 2 simultaneously function as movement limiting elements for the respective adjacent working pistons 15. Furthermore, an insulating sheath 22, which includes a groove 22a as a fluid passage, a coil 22b (equals coil 4), and a connection 22c, is located in the region of an absorber 3. In case of FIG. 4, the regenerators 2 are stationary and include a sheath 2a and a filling 2b, for example metal wool. The movements of the working pistons 15 are, via the coils 2, electromagnetically coupled to a generator consisting of a stator 21 with coils and a rotor 20. The mass of the rotor is dimensioned such that the rotor can intermediately store sufficient energy from the gas expansion of the different stirling modules to cause the gas compression of the different stirling modules by this without stopping its rotation in a certain direction. Instead of a partially mechanical generator, a completely electronic component can also be used to cause the coupling of the working pistons and to generate electric energy. This electronic component can furthermore include a frequency converter which converts the generated current into a current of the desired frequency, or else into direct current. The embodiment shown in FIG. 4 is a multiple-acting thermoelectric converter as the working pistons (15) change volumes of adjacent thermoelectric converter modules each.

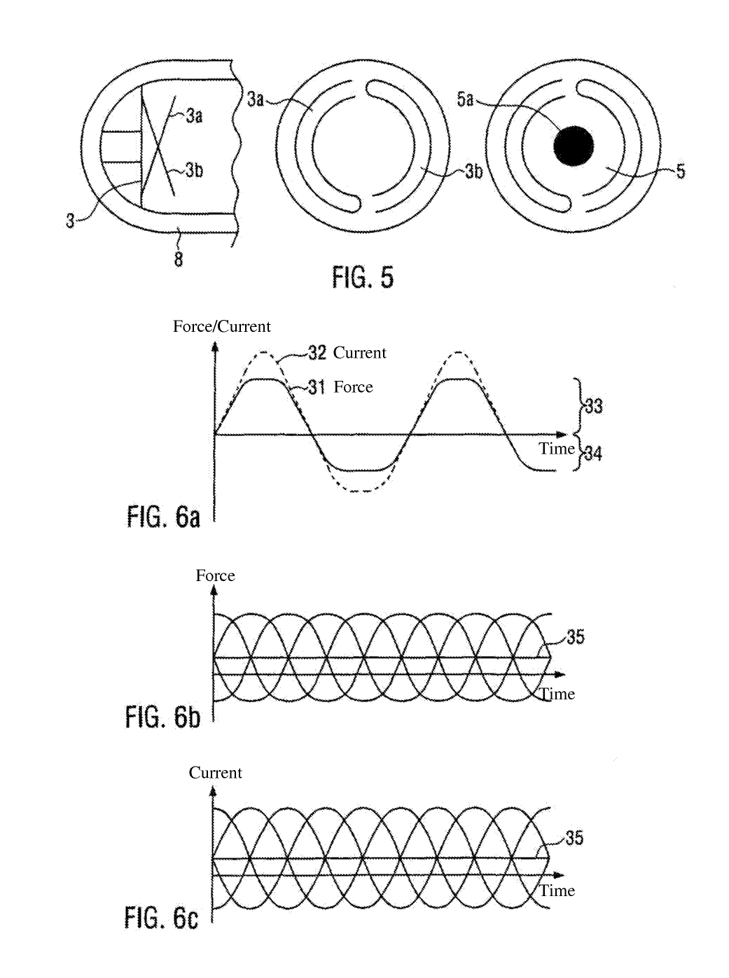

FIG. 5 shows in greater detail an absorber 3 with springs 3a and 3b which function as movement limiting elements. The springs 3a and 3b are essentially helical. The absorber is surrounded by a heat-insulating layer, such as a vacuum 8. Pure movement limiting elements 5 (without absorbers 3) include a passage 5a through which gas moved by the volume change elements can flow.

FIG. 6 illustrates the effect of the movement limiting elements by example of a working piston of a stirling. If a sinusoidal current 32 would be applied to an electromagnetic component, as represented in FIG. 2, the progression 31 of the force acting on the piston can result as the sum of the forces of the electromagnetic component and the movement limiting element. In this case, the stirling would be operated as heat pump: since the sum of the positive forces 33 exceeds the sum of the negative forces 34, work is performed to generate heat and cold. FIGS. 6b and 6c also show force and current progressions as a function of time, where, however, forces or currents, respectively, of several pistons are superposed. The sum of all superposed forces 35 averaged across the various modules is always positive and smoothed compared to an individual module. In operation as a thermal engine (i.e. for generating electric or mechanical energy), one can achieve, in a thermoelectric converter consisting of stirling modules, by the operation of the individual modules with phase shifts with respect to each other that the modules mutually supply or withdraw energy, and that thus no energy must be supplied from outside at any time.

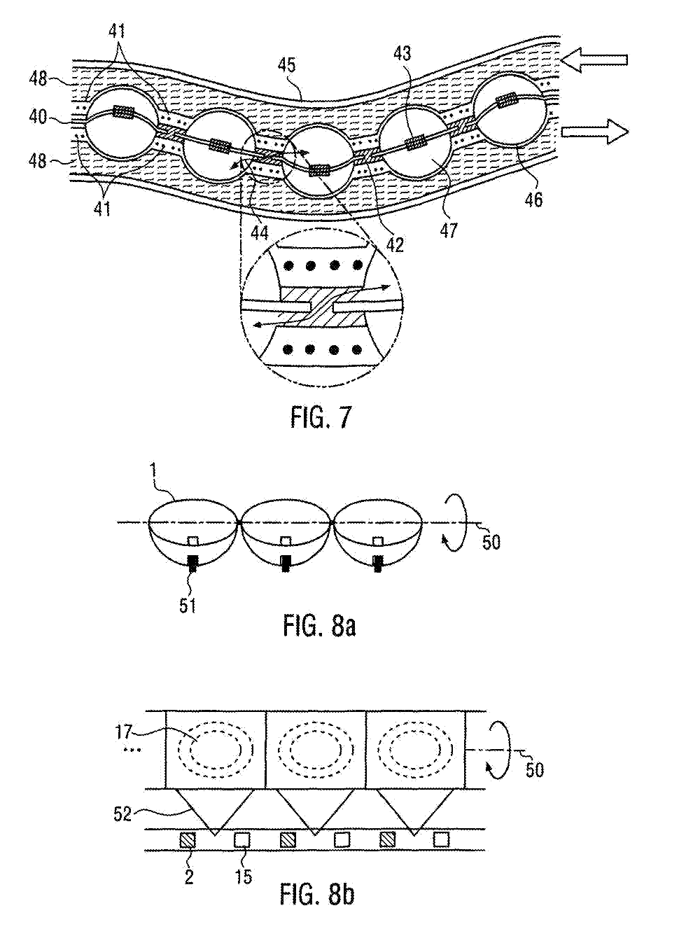

FIG. 7 shows a heat pump or thermal engine which is flexibly designed. Several membranes or membrane regions 40 serve as volume change elements and can be either moved with the aid of coils 41 or induce voltages in the coils 41. The regenerators 42 are located between the gas volumes, moved gas flowing through the generators (indicated by a double arrow 44). The individual working spaces 47 are surrounded by a wall 46. (The membranes or membrane regions 40 are moved with the aid of coils or magnets 41 and 43, respectively). Fluid chambers 48 with opposed fluid flows whose moving directions are indicated by arrows are located above and below the thermoelectric converter modules. The overhead working spaces are connected each only with the working spaces situated left of them at the bottom (see double arrow 44) via the regenerators 42. The embodiment shown in FIG. 7 is a multiple-acting thermoelectric converter because the membrane regions (40) which function as volume change elements each change volumes of adjacent thermoelectric converter modules.

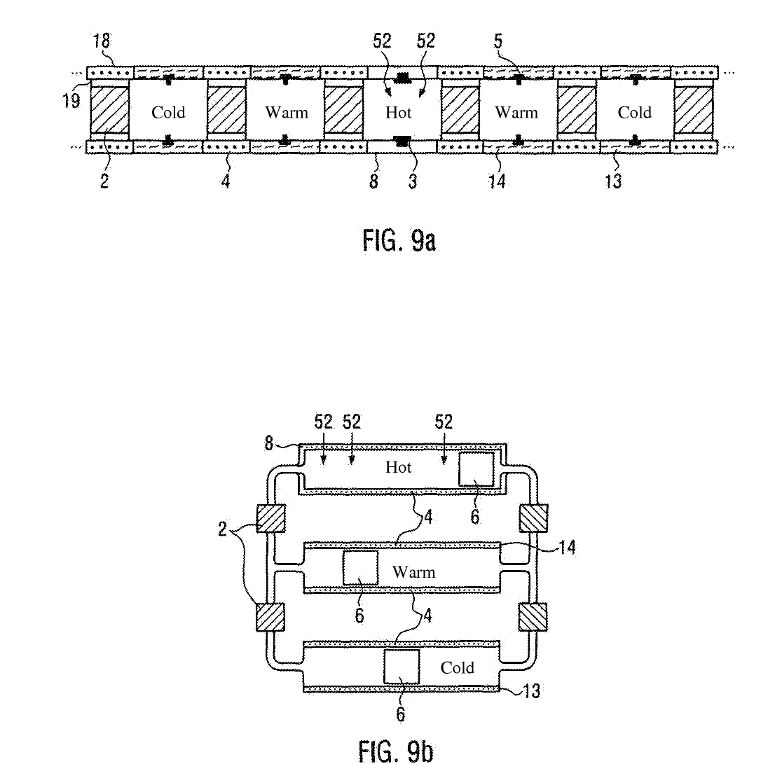

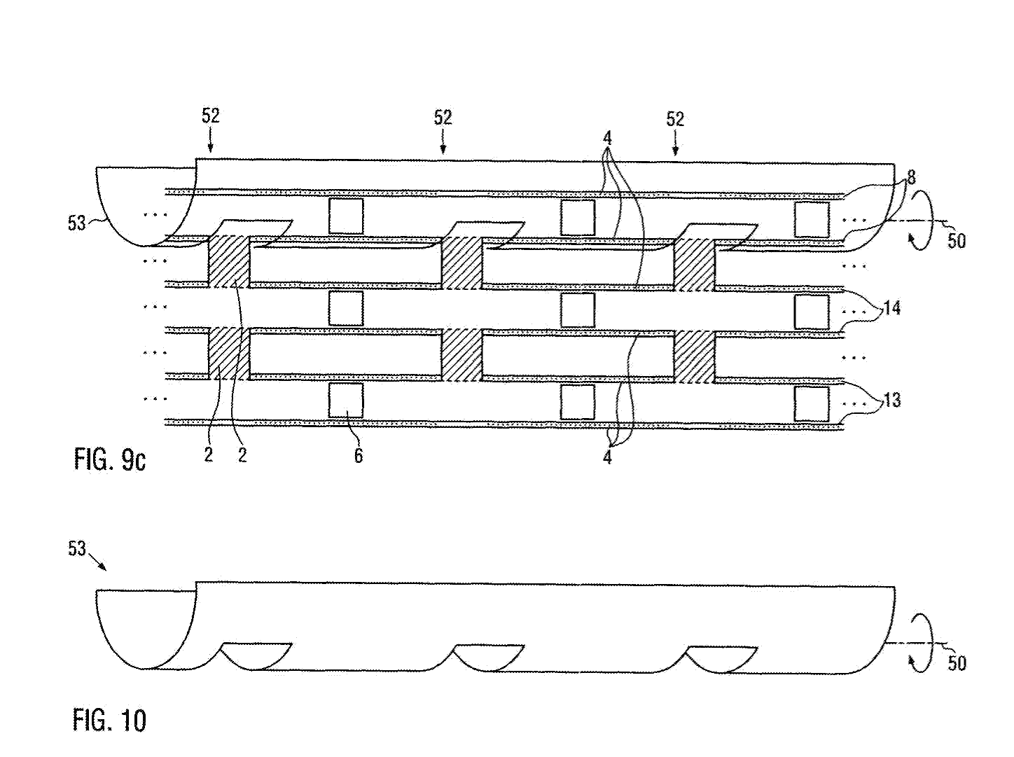

FIG. 8 shows devices for tracking optical elements. The tracking of optical elements makes sense to be able to maximize incident insolation. In FIG. 8a, a tracking of hollow mirrors 1 is shown, and in FIG. 8b, a tracking of a lens array 17 is shown. In both cases, the optical elements can be at least partially rotated about an axis of revolution 50. Apart from or in addition to the rotation, tracking by moving the optical elements relative to the thermoelectric converter modules is also possible. In FIG. 8a, thermoelectric converter modules 51 are furthermore illustrated, and in FIG. 8b, pistons 15 and regenerators 2 are illustrated. Light rays 52 at least partially shine onto said thermoelectric components, so that certain gas volumes of the thermoelectric converter modules are warmed or heated, respectively. Therefore, the tracking of the optical components ensure an improved supply with thermal energy. In FIGS. 8a and 8b, only rows of optical elements are shown. However, thermoelectric converters can consist of several such rows, each row comprising a tracking device, so that the optical elements of one row can be rotated about an axis of revolution 50 each. As shown in FIG. 9c, the optical element can also consist of a linear rotating hollow mirror 53 which bundles the light rays 52 only in one dimension and focuses them onto the respectively hot gas volumes of the thermoelectric converter modules, or the optical element can consist of a cylindrical lens.

In FIGS. 9a and 9c, multiple-acting Vuilleumier cycle designs are shown, in FIG. 9b, a double-acting Vuilleumier cycle design is shown. In all three cases, the designs each have hot, warm and cold gas volumes, where in case of FIG. 9a, the hot, warm and cold gas volumes are arranged such that adjacent Vuilleumier cycle modules mutually use hot or cold gas volumes (a first Vuilleumier cycle module with the gas volume sequence cold-warm-hot, followed by a further Vuilleumier cycle module with the gas volume sequence hot-warm-cold, followed by a further Vuilleumier cycle module with the gas volume sequence cold-warm-hot, this sequence being continued periodically). In case of FIGS. 9b and 9c, there are double- or multiple-acting Vuilleumier cycle machines as in these thermoelectric converters, volume change elements are mutually used by adjacent thermoelectric converter modules. In all three cases (FIG. 9a, FIG. 9b and FIG. 9c), the hot gas volumes are heated with the aid of light rays 52 and absorbers 3 and kept warm with the aid of vacuums 8. In case of FIG. 9a, the components are located in an inner tube 19 which is surrounded by an outer tube 18. In the space between the tubes, a fluid flow 13 moves for the cold transfer, and a fluid flow 14 for the heat transfer. Furthermore, the Vuilleumier cycle design of FIG. 9a includes seals 5 and absorbers 3 which simultaneously function as movement limiting elements for the mobile regenerators 2. In addition, the mobile regenerators can mutually function as movement limiting elements by magnetic repulsion. The mobile regenerators 2 are coupled to each other by means of electromagnetic components 4 (coils). In FIG. 9b, the regenerators 2 are firmly attached to connecting lines between the gas volumes. The displacing pistons 6 are electromagnetically coupled by means of coils 4 (that means, on the one hand, voltages can be induced into the coils, or the coils can be used to create a magnetic field which moves the magnetic displacing pistons 6). Furthermore, the double-acting Vuilleumier cycle machine of FIG. 9b includes a fluid flow 14 for the heat transfer and a fluid flow 13 for the cold transfer. Via the two fluid flows and via the electromagnetic components 4, several Vuilleumier cycle modules can be coupled to each other as in FIG. 9b. The phase shift between the displacing piston 6 in the hot gas volume and the displacing piston 6 in the warm gas volume is typically four, fifth π, and the phase shift between the displacing piston 6 in the hot gas volume and the displacing piston 6 in the cold gas volume is typically one half π for the operation as mere Vuilleumier cycle machine for generating heat and cold. As an alternative, this design can also be preferentially operated as stirling machine for the generation of electric energy and heat, in this case the above mentioned phase shifts typically being one half π or one π, respectively. In this case, waste heat is formed in both fluids, and the displacing piston 6 dephased by half π functions as working piston. The design in FIG. 9c corresponds to the design in FIG. 9b, except for the difference that instead of double-acting Vuilleumier cycle machines, multiple-acting Vuilleumier cycle machines are present, i.e. the gas volumes within the tubes are limited by mobile displacing pistons 6 on both sides.

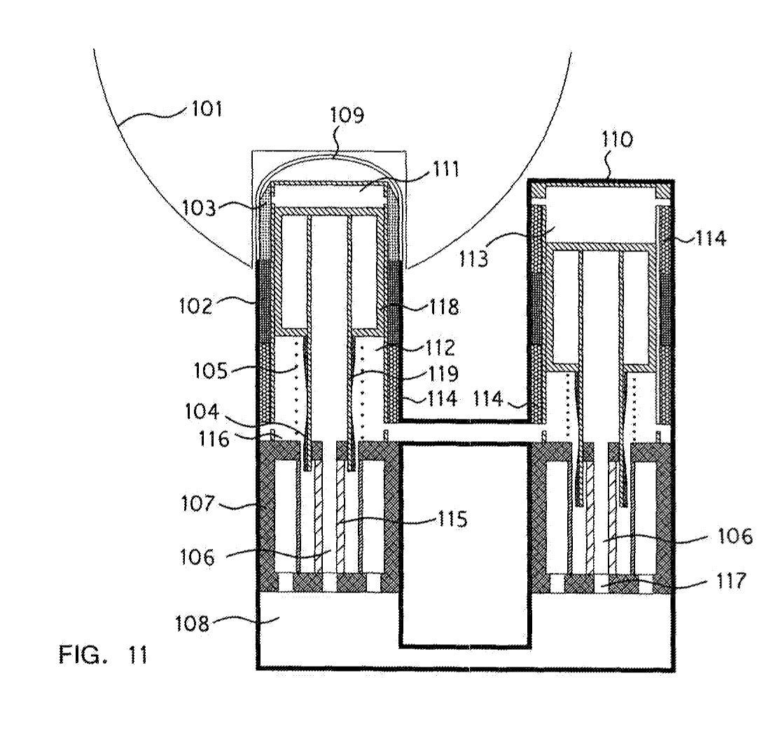

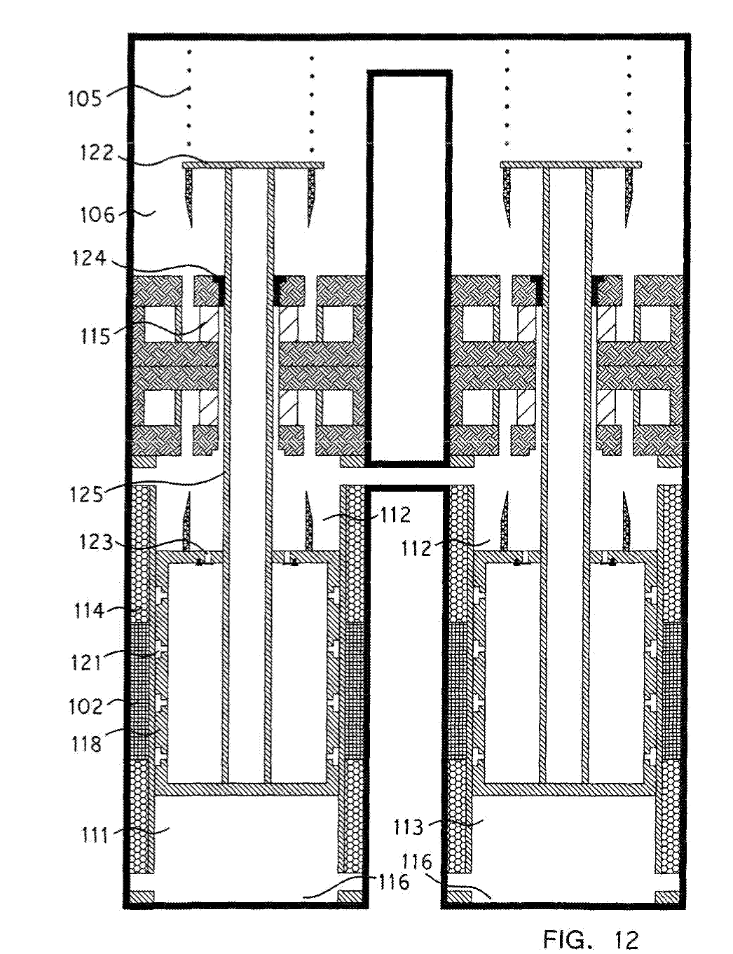

FIG. 10 shows a hollow mirror 53 as it is used in FIG. 9c. The hollow mirror 53 can be rotated about an axis 50 to be able to capture as much light as possible (e.g., in light sources moving relative to the thermoelectric converter, such as the sun). In case of the hollow mirror 53, the light is not focused in a focus, but in a straight line. The gas volume to be heated is typically located in this focus (e.g., in the form of a tube). The hollow mirror 53 has recesses at several points which are suited as passages (e.g., for connecting tubes or lines or mountings, respectively). This type of hollow mirror 53, however, can also be used in other modular thermoelectric converters where the thermoelectric converter modules are at least partially arranged along a straight line.

Mobile regenerators 2, as illustrated, for example, in FIG. 9a, are gas-permeable within limits, so that a mobile regenerator can take up or dissipate heat when gas flows through it. At the same time, quickly moved mobile regenerators can temporarily generate an overpressure or vacuum in the corresponding adjacent gas volume. In case of FIG. 1, FIG. 2, FIG. 3 and FIG. 9a, it is also possible to employ, instead of the mobile regenerators, in each case stationary regenerators in connection with mobile displacing pistons, where in this case, the gas volumes are interconnected via connecting lines such that the gas flowing through heats or cools down the regenerators.

Further aspects of the disclosure and further embodiments of thermoelectric converters according to the disclosure will become clear with reference to FIGS. 11 to 20.

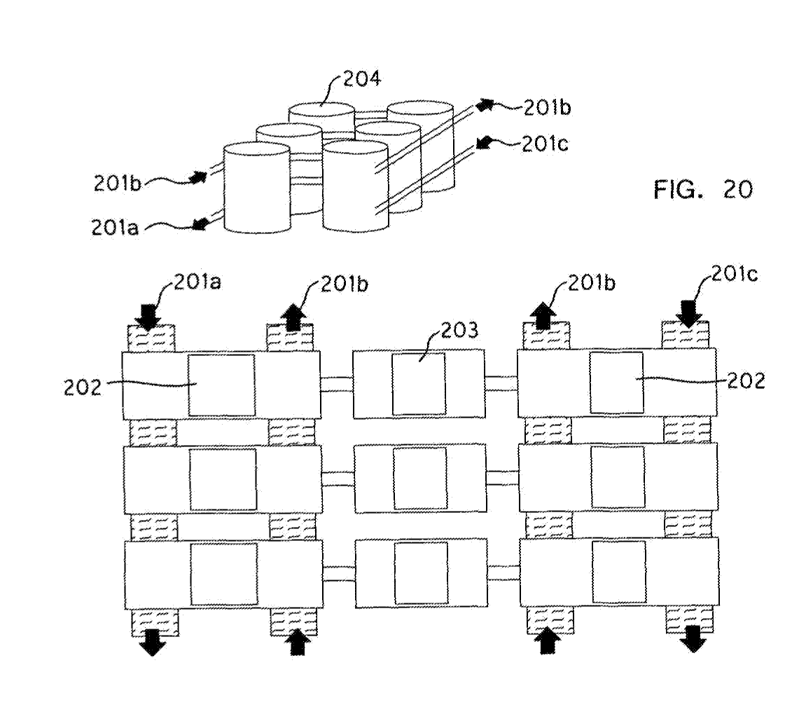

FIG. 11 shows a thermoelectric converter using gas springs 106. It has two cylinders which are each rotationally symmetric and pistons 118 which each have a hollow piston rod 119. Incident light is bundled by a pivoting hollow mirror 101 such that the major part of it impinges on the light absorber 103 which is heated by the absorbed light. This heat can be used to heat a first gas volume 111, so that this gas volume expands and presses down the piston located under it. The regenerator 102 is underneath the light absorber 103. Underneath the piston 118, there is a multiwire power supply 105 for mobile coils 104 which can simultaneously function as mechanical spring and in this case counteracts an excursion of the piston from its home position. In the lower region of the piston, there are coils 104 which serve to accelerate and decelerate the piston. The coils 104 can consist of several segments and/or they can be embodied with varying winding densities each leading to a varying induction effect occurring depending on the piston excursion. The effect of this is that the piston movement is influenced by the varying winding density such that the piston movement is more or less decelerated or accelerated. Within the yoke 107, there is a permanent magnet 115 in the form of a tube in the shown embodiment. The yoke 107 is used to permit a magnetic circuit. The gas springs 106 exert a repulsive force on the piston in case of an excursion of the latter from its home position. In addition to the gas spring 106 in the central region of the piston, further gas springs 116 can be used in the region of the maximum piston excursion. The additional gas springs can function as movement limiting element or as protection so that the piston does not touch the adjacent wall. The gas springs 106 in the central region of the piston can be embodied such that, by the smaller cross-section in the second gas volume 112 compared to the first gas volume 111 and to the third gas volume 113, the pistons are driven by supplied thermal energy. Therefore, the gas spring 106 is also referred to as “rest stirling”. The additional space 108, which is connected with the gas springs 106 by holes 117 in the yoke, can serve to reduce the repulsive force of the gas spring and to couple the gas springs of the two pistons. Furthermore, in FIG. 11 heat exchangers 114 for dissipating heat (adjacent to the gas volume 112) or cold (adjacent to the gas volume 113) are shown. The heat exchangers 114 can be coupled to a fluid, as shown in FIG. 20, which transfers heat/cold to a place outside the cylinders. Apart from the pivoting hollow mirror 101, all above mentioned components are mounted in a pressure housing 110 which can resist a pressure of, for example, 10 bar. This permits operation of the thermoelectric converter with a gas at overpressure. In the region of the hollow mirror 101, the pressure housing 110 has a glass wall or a double- or multiple-glass wall 109 which is transparent.

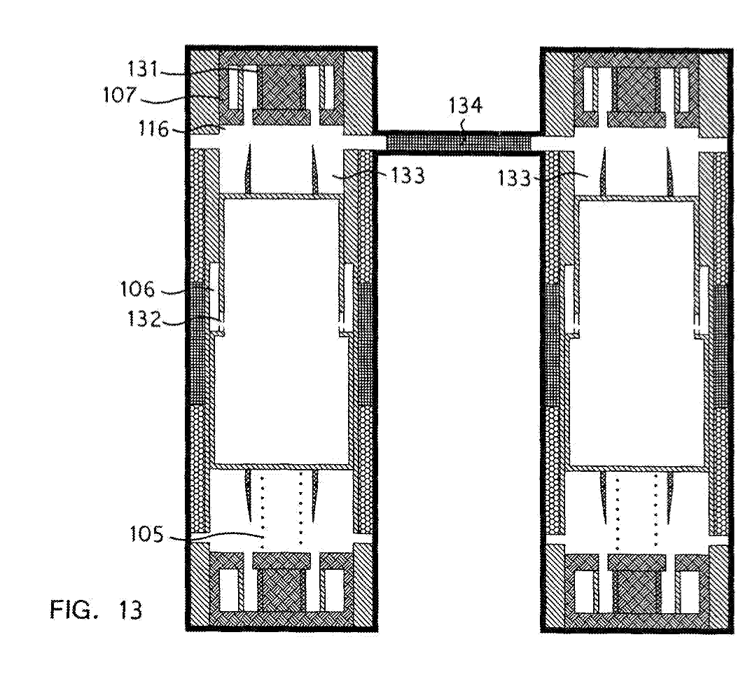

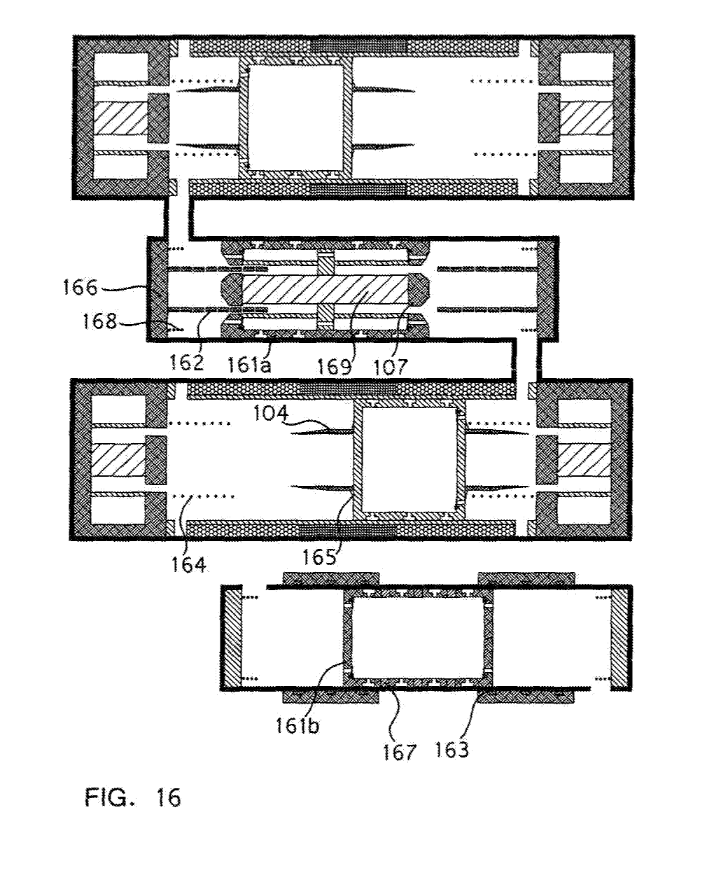

Another thermoelectric converter with gas springs is shown in FIG. 12 (electric or electronic elements are not represented here and in the other illustrations, except for coils). In addition to the components already mentioned in FIG. 11 (such as, for example, gas springs 106, regenerators 102, heat exchangers 114, permanent magnets 115, movement limiting elements 116), piston rods 125 are shown in FIG. 12 which in the gas spring room 106 are connected with a fixing element 122 for mobile coils 104. Further mobile coils are fixed at the piston within the second gas volume. The first gas volume 111, which is typically warmer than the second gas volume, and the third gas volume 113 do not contain any coils, whereby resistance loss is avoided. The piston rod is guided by a sliding bearing 124 which can also be replaced by a gas bearing as is represented e.g., in FIG. 15. Furthermore, in FIG. 12 outlets 121 for air or gas are shown which function as air or gas bearings. The air or gas bearings 121 can reduce the frictional resistance of the pistons, in turn resulting in a higher efficiency (due to reduced frictional losses) of the thermoelectric converter. The valves 123 serve to create overpressure inside the piston by which the gas bearings 121 are supplied.

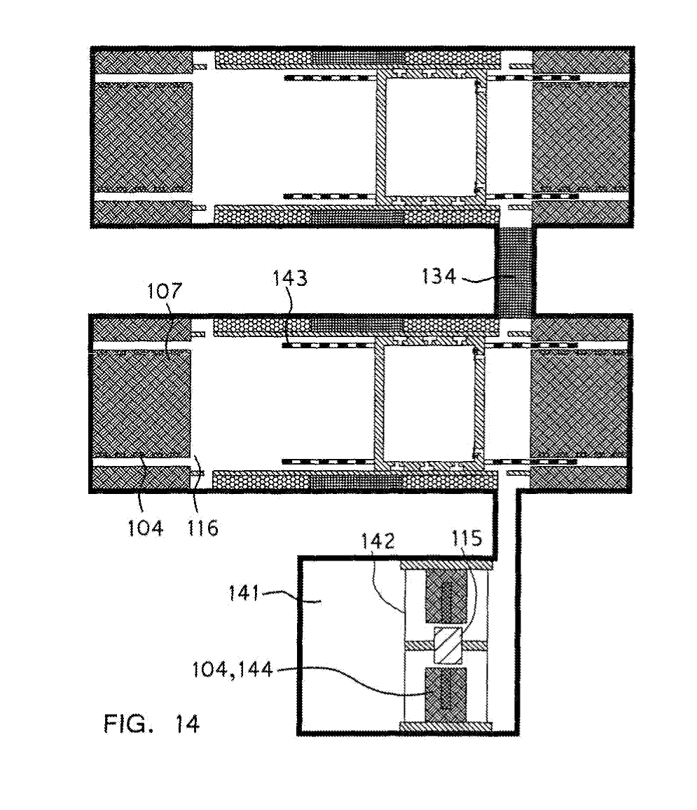

FIG. 13 shows a thermoelectric converter with gas springs 116 as movement limiting element and in particular with a coil 131 functioning as a field winding for creating a magnetic field. As an alternative, this component 131 can be replaced by a permanent magnet. The magnetic circuit is effected by the yoke 107. Furthermore, a hole 132 is shown in FIG. 13 which functions to increase the volume of the gas spring 106 by the volume of the interior of the piston. By this volume increase, the gas spring 106 becomes softer, i.e. the repulsive force on the piston is reduced. To drive the piston by thermal energy, the cylinder cross-section 133 in the warm working space is smaller than in the hot and in the cold working space. This design option is also referred to as “rest stirling”. An additional regenerator 134 is used to be able to work in the left cylinder with another temperature level of waste heat or useful heat than in the right cylinder.

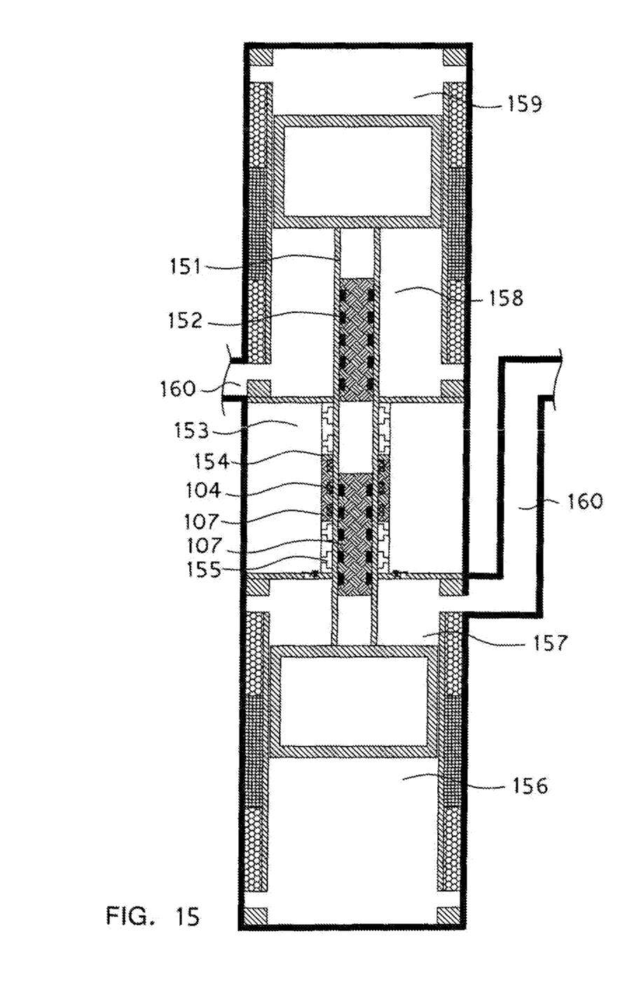

FIG. 14 shows a thermoelectric converter with an additional cylinder 141. This additional cylinder can also be employed in the following FIG. 16 instead of the central cylinder with the working piston. If it is omitted, the pistons must be driven by an external power source. Within the cylinder 141, there is a membrane, a spring band steel or a flat spiral spring 142, underneath of which there are a permanent magnet 115 and a yoke 144 with a coil 104. The permanent magnet 115 is fixed to the membrane or the spring band steel or the flat spiral spring 142, respectively. By the oscillation of the permanent magnet 115, voltage for driving the displacing pistons is induced. A current formed in this way can be intermediately stored in a capacitor or in an accumulator (not shown). In case of the thermoelectric converter of FIG. 14, too, a gas spring 116 is used as movement limiting element. Moreover, a yoke 107 of ferrite or in the form of a laminated core is shown which helps to avoid eddy current losses. Several coils 104 are wound around the yoke 107 and serve to create a locally migrating magnetic alternating field. By this, the piston can be decelerated or accelerated, respectively. In case of FIG. 14, the piston is embodied such that electric ring conductors or short-circuit conductors 143 are attached to the piston. The electric ring or short-circuit conductors can consist of segments or of a continuous tube section. An additional regenerator 134 is used to be able to work in the left cylinder with another temperature level of waste heat or useful heat than in the right cylinder.

FIG. 15 shows another embodiment of a thermoelectric converter. In this embodiment, an internally hollow piston rod 151 is employed. Ring conductors 152 are located in the piston rod 151. As an alternative to the ring conductors 152, one or several annular or discoidal permanent magnets are possible. In the region of the ring conductor 152, there also is one yoke 107 each of ferrite or in the form of a laminated core. There is an overpressure in the space 153 which supplies the air bearing 155 for the piston. Following the yoke 107 or the ring conductors 152, there are coils 104 for the creation of a migrating magnetic field. In the region 154, the piston drive is separated from the working gas. By this, negative influences of the hot working gas on the electric components are reduced. Negative influences on the electric components could be, for example, an increasing ohmic resistance or damage to permanent magnets. The air bearing 155 is furthermore shown in FIG. 15 which serves to compensate the magnetic attraction force of the rod 151 against the cylinder wall. The above discussed type of drive is also advantageous for a working piston or a Vuilleumier cycle module with rest stirling, in particular because the magnetic attraction force in the regions of maximum excursion can compensate the repulsive pressure of the working gas or of the gas spring completely or partially. The cylinder shown in FIG. 15 contains gas volumes belonging to two different Vuilleumier cycle modules: the first, hot gas volume 156 and the warm, second gas volume 157 belong to a Vuilleumier cycle module which is connected to another adjacent and identically designed cylinder via the connecting tube 160. In this adjacent cylinder, there is the second part of the second, warm gas volume 158 and the third, cold gas volume 159. In this way, altogether 2, 3, 4 or more than 4 of such cylinders can be connected in series, the gas volume 157 of the last cylinder being in turn connected to the gas volume 158 of the first cylinder via a connecting tube 160. The above described design is also possible as an alternative to the represented linear asynchronous drive with a multi-solenoid drive (in this case, the ring conductors 152 would be replaced by annular permanent magnets), or the plunger coil drive.

FIG. 16 shows a thermoelectric converter in the form of a duplex stirling which can be used both for generating electric energy and as a heat pump. Current is here transferred to the mobile coils 104 of the displacing pistons by movement limiting elements 164 which are electrically conductive and, in contact with the piston, are connected with the coils via at least 2 electric contact points 165 each in an electrically conductive manner. In contrast to Vuilleumier cycle machines, this arrangement includes a working piston 161a. The working piston 161a is in this embodiment equipped with a permanent magnet. Magnetic attraction is accomplished between the piston and the yoke 166 located at the end of the cylinder which reacts to the repulsive force by the gas volumes compressed or expanded by the piston. Movement limiting elements 168 in the form of springs prevent the working piston from touching the cylinder ends. Segmented coils 162 are used to reduce electric losses, which in turn increases the efficiency of the duplex stirling. As an alternative to the working piston 161a, the working piston 161b can be used. This piston is ferromagnetic and provided with ring magnets 167 which can create a locally alternating magnetic field. In this embodiment, a migrating magnetic field is created with the aid of field windings or coils 163, respectively, which are supplied with polyphase current. In the region of the maximum piston excursion, the magnetic field additionally retains the piston in this position and reacts to the pressure of the compressed working gas. Furthermore, as an alternative to the working pistons 161a and 161b, a working piston can be used which in contrast to the displacing piston oscillates within its resonant frequency and which is decelerated or accelerated by an electromagnetic component arranged in the region of its center of movement. In operation as a heat pump, the working piston 161a or 161b does not necessarily have to be driven or decelerated by electromagnetic interaction with coils 162 or 163, but it can simply perform a harmonic oscillation. As an alternative, the electromagnetic component can completely be omitted in the working piston, so that the working piston exerts a harmonic oscillation within its resonant frequency. The oscillations of the displacing pistons and the working piston of the arrangement represented in FIG. 16 are coupled via the electromagnetic components such that they are each correlated with a certain phase shift. It is possible to determine various phase shifts by the not represented control apparatus or to control them in response to measurands. By this one can achieve that either more useful heat or useful cold is generated, or that, as an alternative, more electric energy is generated. As an alternative to the representation in FIG. 16, at least one displacing piston and at least one working piston can also be arranged one behind the other in the same cylinder, wherein the oscillations of both pistons can be coupled by a spring or a gas spring.

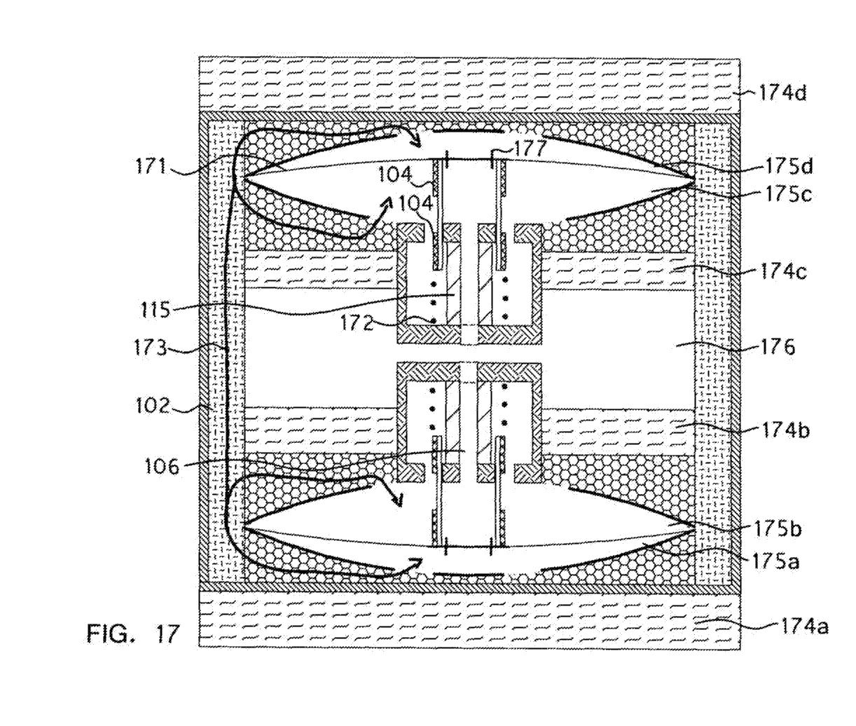

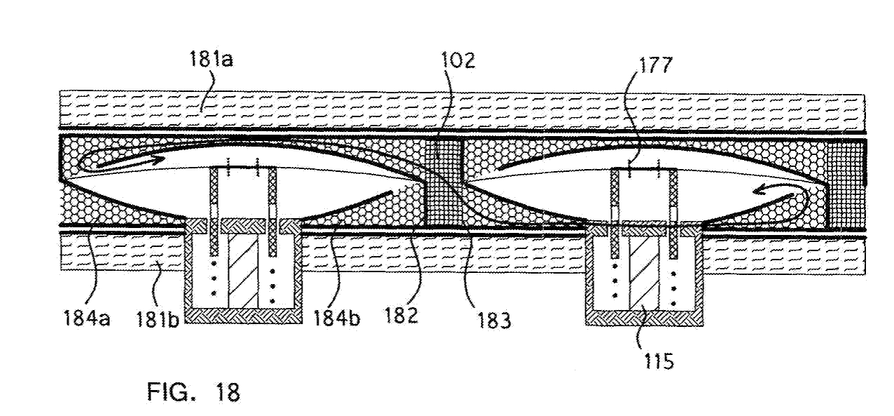

In FIG. 17, a Vuilleumier cycle machine with membranes 171 is shown. The membranes 171 function as volume change elements. In the shown embodiment, mechanical springs 177 are employed as movement limiting elements. The gas springs 106 form the rest stirling for driving the membrane oscillation. Furthermore, the Vuilleumier cycle machine of FIG. 17 includes an additional space 176 for the gas springs 106 whereby the oscillations of the membranes can be further designed. By the oscillation of the membranes, by means of the coils 104 and the, for example, tubular permanent magnets 115, electric voltage is generated. The power supply 172 for the coils 104 is located adjacent to said coils 104. The path 173 of the working gas through the gas-permeable heat exchangers or regenerators 102, respectively, is indicated by lines and arrows, respectively. Depending on the excursion of the membranes 171, the direction of the working gas (and thus the arrow direction of the path 173) changes. In the Vuilleumier cycle machine of FIG. 17, working spaces 175 and fluids 174 for taking up or dissipating thermal energy are shown. The working spaces 175, which typically contain gas, are shown, that is a hot working space 175a, a warm working space 175b, another warm working space 175c, and a cold working space 175d. The corresponding temperatures of the working spaces 175 are transferred to the fluids 174. The fluid 174a which provides thermal energy for the operation of the Vuilleumier cycle machine dissipates thermal energy to the heat exchanger situated above it which is thermally coupled to said fluid 174a. The fluid 174b for useful and waste heat takes up thermal energy from the heat exchanger situated below it and to which it is thermally coupled. Analogously, the fluid 174c for useful or waste heat takes up thermal energy from the heat exchanger situated above it and to which it is thermally coupled. The cold produced by the Vuilleumier cycle machine can be released to the fluid 174d for useful cold, or it can be intermediately stored by it until it is further used.

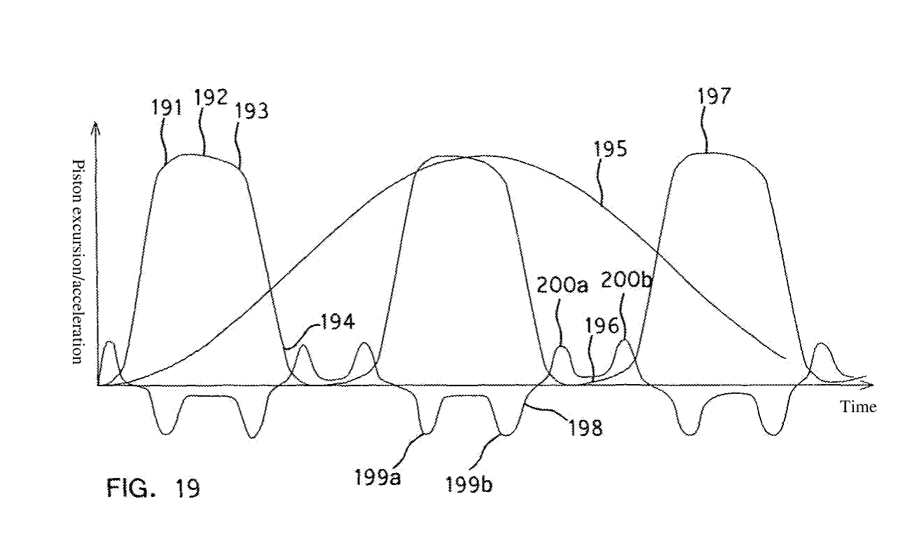

FIG. 18 shows a flat modular stirling with membranes and modules situated one next to the other, only two of them being explicitly shown in this picture. However, more of such modules can be located laterally adjacent to the left and right. As movement limiting elements, springs 177 are used. Regenerators 102 are arranged each between the individual modules, the regenerators being not gas-permeable in the region 182 and gas-permeable in the region 183, so that a gas flow is permitted as is indicated by a double arrow (that means from the top left to the bottom right, or from the bottom right to the top left through the regenerator 102). The two heat exchanger halves 184a and 184b are interconnected in a gas-permeable manner. For supplying thermal energy, a warm or hot fluid 181a is used, and for dissipating useful or waste heat, a cold fluid 181b is used. The shown modular stirling with membranes can also be driven by supplying electric energy as a heating or cooling element. In this embodiment, permanent magnets 115 are used in the individual stirling modules.

FIG. 19 shows the typical piston excursion (or in general the movement of a volume change element) of a thermoelectric converter as a function of time. The piston moves between a lower turning point 196 and an upper turning point 197. In the region 191, the piston is decelerated. This is done above all by induction in a coil. In the region 192, repulsive forces of the gas springs, mechanical springs or the movement limiting elements can act on the piston and be reduced by a braking effect of the electromagnetic components to such an extent that the piston remains for a longer time in this region and thus exerts the desired mode of oscillation. This can be supported by magnetic attraction forces as is shown in the working pistons in FIG. 16. It is furthermore possible for the energy transmission to be effected in this region, for example, in a capacitor. In the region 193, the piston is accelerated by the movement limiting element, a gas spring, mechanical springs and/or the electromagnetic component. The course of the curve 194 shows that by the electromagnetic actuation in the regions of maximum excursion, the oscillation frequency can be increased with respect to the harmonic oscillation 195, and the oscillation becomes similar to a square wave. As an alternative, the oscillation frequency can also be reduced with respect to the harmonic oscillation 195. Both are done by open-loop/closed-loop control of the decelerating or accelerating effect of the electromagnetic components by the control system. The curve 198 shows the typical acceleration of a piston over time. Here, the occurrence of two local minimums 199a and 199b, or two local maximums 200a and 200b per half oscillation of the piston are characteristic of the present disclosure. Compared to the above-discussed piston movement 194, a harmonic oscillation 195 of a working piston or displacing piston with a gas spring or mechanical spring is represented which acts across the complete stroke. The progression 195 corresponds to the movement of a piston of a conventional free-piston stirling or a conventional free-piston Vuilleumier cycle machine. By the piston progression 194, higher efficiency is achieved in this disclosure, in contrast to a harmonic oscillation 195.

In FIG. 20, the countercurrent principle is illustrated. This countercurrent principle is employed, for example, in Vuilleumier cycle modules, as is shown e.g., in FIG. 12, or in duplex stirling modules, as is shown, for example, in FIG. 16. In a simplified manner, only the cylinders 204 of Vuilleumier cycle modules, as shown e.g., in FIG. 12, or displacing pistons 202 and working pistons 203, as known from FIG. 16, are represented here. Flows of hot fluids 201a, warm fluids 201b, and cold fluids 201c are represented, wherein one fluid flow further warms up or cools down in the further progression, depending on the type of application. These fluids are thermally coupled to the gas volumes of the thermoelectric converter modules via the heat exchangers 114, as is represented e.g., in FIG. 12. The countercurrent principle helps to keep the thermal difference between adjacent fluid flows (e.g., hot and warm or warm and cold) in each thermoelectric converter module as low as possible, whereby a higher efficiency of the corresponding thermoelectric converter can be achieved.

Apart from the embodiments discussed in the figures, further embodiments are possible, where the above-described components can be used in any other combinations.

1. A thermoelectric converter for converting heat, cold and/or sunlight into electric energy and/or for generating heat and cold, comprising:
at least one thermoelectric converter module comprising at least first and second spatially delimited gas volumes which are interconnected by a regenerator in a gas-permeable manner, wherein the first gas volume in operation of the thermoelectric converter is warmer than the ambient temperature of a fluid flow, wherein the first gas volume is arranged to be heated by a heat source, wherein the second gas volume in operation of the thermoelectric converter is colder than the first gas volume, and wherein the thermoelectric converter module comprises at least one volume change element suited for changing the size of at least one of the gas volumes;
wherein the volume change element is arranged to be moved and/or deformed with the aid of an electromagnetic component by creating a magnetic field, wherein the size of at least one of the first and second gas volumes is changed by the movement of the volume change element; and
a first fluid flow region thermally coupled with the second gas volume, the first fluid flow region arranged to conduct a first fluid flow to dissipate heat from the second gas volume.

2. The thermoelectric converter according to claim 1, further comprising at least a second said thermoelectric converter module.

3. The thermoelectric converter according to claim 2, wherein the thermoelectric converter comprises at least 3 times 3 of said thermoelectric converter modules.

4. The thermoelectric converter according to claim 2, each of the thermoelectric converter modules further comprising:
a second fluid flow region thermally coupled with a third gas volume, the second fluid flow region arranged to conduct a second fluid flow to dissipate cold from the third gas volume;
wherein the third gas volume is, in operation of the thermoelectric converter, colder or warmer than the corresponding second gas volume of the respective thermoelectric converter module, wherein the fluid flow modules are connected in series by the first fluid flow and the second fluid flow, and wherein the first fluid flow and the second fluid flow are arranged to flow in opposite directions, so that in a first thermoelectric converter module, both fluid flows have maximum temperatures, and so that in a last thermoelectric converter module, both fluid flows have minimal temperatures.

5. The thermoelectric converter according to claim 1, wherein each thermoelectric converter module furthermore comprises a movement limiting element that limits the movement of the respective volume change element such that the volume change element can perform an oscillation that deviates from a sinusoidal shape.

6. The thermoelectric converter according to claim 1, wherein the thermoelectric converter module comprises a stirling module, a duplex stirling module, and/or a Vuilleumier cycle module, and wherein the thermoelectric converter module generates electric current and/or mechanical work and/or heat and/or cold.

7. The thermoelectric converter according to claim 1, further comprising:
a control system for controlling oscillation frequency, amplitude, mode of oscillation, and phase shift of each volume change element of the thermoelectric converter module, wherein the control of the oscillation frequency, amplitude, mode of oscillation, and phase shift is provided with the aid of the respective electromagnetic component of the thermoelectric converter module.

8. The thermoelectric converter according to claim 1, wherein the volume change element comprises a loose piston.

9. The thermoelectric converter according to claim 1, wherein the volume change element is arranged to perform an oscillation whose oscillation frequency differs by at least 10%, 25%, 50% or 75% from the resonant frequency of a corresponding volume change element not coupled by the electromagnetic component.

10. The thermoelectric converter according to claim 1, wherein the electromagnetic component contains at least two plunger coils, or at least one multi-solenoid drive, or at least one electromagnetic asynchronous drive for moving or deforming the volume change element.

11. The thermoelectric converter according to claim 1, wherein the volume change element can perform oscillations with a waveform that comprises turning points having a gradient that differs from the gradient in the turning points of a corresponding sine waveform of the same wavelength and amplitude by at least 10%, 20%, 30% or 50%, and wherein the absolute value of the gradient is higher than the corresponding absolute value of a gradient of a sine waveform having the same wavelength and amplitude.

12. The thermoelectric converter according to claim 1, comprising at least four gas volumes, wherein the first gas volume is connected to the second gas volume through a regenerator in a gas-permeable manner, the second gas volume is connected to the third gas volume through a regenerator in a gas-permeable manner, and the third gas volume is connected to the fourth gas volume through a regenerator in a gas-permeable manner.

13. The thermoelectric converter according to claim 1, wherein at least one volume change element undergoes, in the regions of its maximum excursion, a force component in the direction away from a center of movement of the volume change element caused by attraction of two ferromagnetic elements.

14. A method of using the thermoelectric converter according to claim 1, wherein the method comprises the steps of:
arranging the thermoelectric converter such that it is exposed to light and/or heat and/or cold; and
generating electric current and/or mechanical work and/or heat and/or cold.

15. The method according to claim 14, wherein temperature of the fluid flow is controlled via flow rate of the fluid flow.

16. The thermoelectric converter according to claim 1, wherein the heat source comprises an optical element or a thermal coupling to a fluid.

17. The thermoelectric converter according to claim 1, wherein the electromagnetic component comprises a magnet, an electrically conductive coil, or a short-circuited electric conductor.

18. The thermoelectric converter of claim 1, wherein the volume change element comprises a mobile piston, a rotating piston, or a rotary piston.

19. The thermoelectric converter of claim 1, wherein the volume change element comprises a mobile or deformable membrane.

20. The thermoelectric converter of claim 1, wherein the volume change element comprises a mobile regenerator.

21. The thermoelectric converter according to claim 3, wherein the thermoelectric converter modules are movable relative to each other in a manner such that the thermoelectric converter is adaptable to conform to different shaped surfaces.

22. The thermoelectric converter of claim 5, wherein the movement limiting element comprises at least a spring, a stop, a magnet, a gas spring, or an electronic element for controlling the electromagnetic component.

23. The thermoelectric converter of claim 1, further comprising a device for converting energy supplied and/or released by the thermoelectric converter modules into electric energy of another form comprising alternating current of a predefined frequency.

24. The thermoelectric converter of claim 1, wherein the electromagnetic component contains at least one coil having a winding density that is variable along an axis of the coil.

25. The thermoelectric converter according to claim 1, wherein the volume change element is arranged to perform an oscillation that is approximately rectangular or trapezoidal.

26. The thermoelectric converter according to claim 1, wherein a function of acceleration of the volume change element comprises at least two local maximums or two local minimums over a time between two passages through a center of movement of the volume change element.
